(19) United States
(12) Patent Application Publication
(10) Pub. No.: US 2025/0335630 A1
(43) Pub. Date: Oct. 30, 2025

(54) SYSTEM AND METHODS FOR ESTABLISHING AND LEVERAGING SECURE ACCESS TO DATA ACROSS WI-FI NETWORKS

(71) Applicant: PLUME DESIGN, INC., Palo Alto, CA (US)

(72) Inventors: Miroslav SAMARDZIJA, Mountain View, CA (US); Liem Hieu Dinh VO, San Jose, CA (US)

(21) Appl. No.: 18/648,676

(22) Filed: Apr. 29, 2024

(51) Int. Cl. G06F 21/62; H04W 12/02

(52) U.S. Cl. CPC G06F 21/6254; H04W 12/02

(57) ABSTRACT

A Wi-Fi network-based system and methods are disclosed for securely managing and accessing secure user data. The system includes various Wi-Fi network configurations utilizing access points, mesh nodes, repeaters, and devices to facilitate data collection. A cloud-based management approach enables centralized control and efficient resource management. The system features a secure data processing application for real-time modification (and/or encryption) of user data at collection points, coupled with an access management application for managing secure data storage and access. The access management application enables a user to create multiple permission settings for requesters for data acquisition. Additional modules for consent management, user profile creation, data delivery, transaction recording, and key management ensure security and privacy compliance. The system offers a comprehensive solution for data security, addressing the challenges of protecting sensitive user data in digital platforms and complying with privacy regulations.

### FIELD OF THE DISCLOSURE

The present disclosure generally relates to the field of data security and management in electronic systems, and more particularly, to a decision intelligence (DI)-based computerized framework for establishing access to secure data for purposes of facilitating user engagement across a plurality of locations.

### BACKGROUND

With the increasing reliance on digital platforms for various transactions and interactions, there is a growing volume of user data being generated and collected. This data often includes sensitive personal information that requires protection from unauthorized access and breaches. In conventional systems, user data is collected through various means, such as during online transactions, interactions with smart devices, or through the use of services that require personal identification. The collected data is typically stored in databases that may be vulnerable to security threats, leading to potential misuse of personal information.

### SUMMARY

The challenge, among other technical shortcomings with existing systems, lies in developing a system that not only collects and stores user data efficiently but also ensures the data is encrypted and remains secure against unauthorized access. Furthermore, there is a need for a management system that can control access to the encrypted data, allowing only authorized entities to retrieve or use the information for legitimate purposes.

Encryption techniques transform readable data into an unreadable format, which can only be reverted to its original form through a decryption process using specific keys. However, the management of encryption keys and access rights presents its own set of complexities. The system must be capable of handling key distribution, revocation, and access control policies to maintain the integrity and confidentiality of the data.

Additionally, with the advent of regulations aimed at protecting user privacy, there is an increased emphasis on ensuring that user data is handled in compliance with legal standards. This includes providing users with control over their data and the ability to grant or revoke consent for data usage.

Therefore, there is a need for a technological solution that addresses these challenges by providing a secure method for collecting, encrypting, storing, and managing access to user data.

To that end, the present disclosure provides a Wi-Fi network-based system and methods for establishing secure access to encrypted data. The system is designed to address the challenges of data security and management in electronic systems, particularly in the context of the increasing volume of sensitive user data generated and collected through digital platforms. The disclosed system offers a comprehensive solution for collecting, encrypting, storing, and managing user data, ensuring protection against unauthorized access and compliance with privacy regulations.

In some embodiments, the system includes various configurations of Wi-Fi networks that support data collection and encryption processes. These networks, which may be physical or cloud-based, utilize components such as access points, mesh nodes, repeaters, and devices to facilitate network access and data transmission. The system is adaptable to different network topologies, each designed to optimize performance factors such as coverage, interference, and congestion.

The system includes a cloud-based management approach that enables centralized control over multiple Wi-Fi networks. This approach allows for efficient resource management, data analysis, and node configuration, leveraging cloud computing to provide scalable and on-demand network access with minimal manual intervention.

In some embodiments, the system includes a secure data processing application that performs real-time encryption of user data at the point of collection. This application, along with an access management engine (e.g., an executable application, which can be stored on a device, or executable over a network as hosted by a cloud device/server, for example), facilitates the secure storage and management of encrypted data, allowing only authorized entities to access the information.

The system further comprises a data marketplace module that creates a secure online platform for users to control and monetize their anonymized and aggregated data. The module enables users to offer their data for public bidding and/or sale, providing granular control over the degree of data anonymization and the structure of data sales. Businesses, researchers, and other entities can participate in the bidding process to acquire valuable consumer behavior insights.

Additional modules, such as a consent management module, a user profile creation module, a data delivery module, a transaction module, and a key management module, work in concert to ensure the system's security, privacy compliance, and operational efficiency. These modules enable users to manage consent settings, create profiles for data requesters, securely transmit encrypted data, maintain transaction records, and manage encryption keys, including their generation, distribution, and revocation.

### DESCRIPTIONS OF THE DRAWINGS

The features, functionalities, and advantages of the disclosed data collection system leveraging Wi-Fi technology will become more apparent from the following detailed description and the accompanying drawings, in which reference characters refer to the same parts throughout the various views. The drawings are not necessarily to scale, with emphasis instead being placed upon illustrating the principles of the disclosed data collection system:

FIG. 1 is a block diagram illustrating various configurations of Wi-Fi networks designed for internet connectivity and adapted for use in the data collection system according to some embodiments of the present disclosure;

FIG. 2A is a schematic representation of a Wi-Fi network incorporating cloud-based management and connecting through various gateway devices to a modem/router linked to the internet, facilitating centralized control over multiple Wi-Fi networks for data collection according to some embodiments of the present disclosure;

FIG. 2B introduces a distributed system in a tree topology within a Wi-Fi network, optimizing efficiency and signal coverage for environments unsuitable for single access points, repeaters, or mesh networks according to some embodiments of the present disclosure;

FIG. 3 depicts a diagram outlining the basic components found in a broadcast network, including access points, mesh nodes, repeaters, and other network devices configured to support the data collection system according to some embodiments of the present disclosure;

FIG. 4 illustrates a server with core components configured to support cloud-based Wi-Fi network management and optimization for various types of data according to some embodiments of the present disclosure;

FIG. 5 shows a system architecture including interfaces between cloud based engines, data collection terminals, access management interfaces, and third party requesters according to some embodiments of the present disclosure;

FIG. 6 shows a non-limiting example of algorithmic steps executed by the system for data collection and redistribution according to some embodiments of the present disclosure;

FIG. 7A illustrates an access management interface for the data marketplace according to some embodiments of the present disclosure; and

FIG. 7B shows an access management interface for managing access permissions according to some embodiments of the present disclosure.

### DETAILED DESCRIPTION

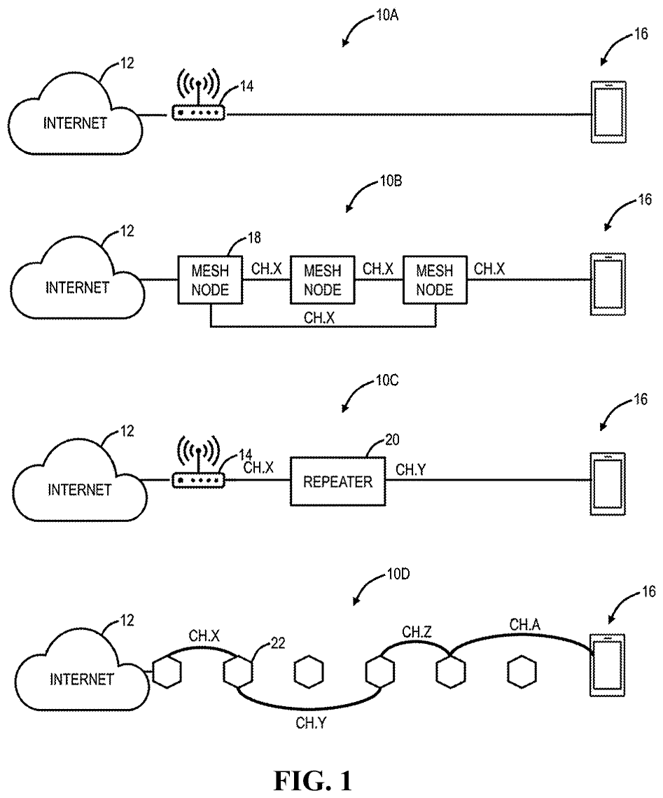

Illustrated in FIG. 1, the system includes various configurations of Wi-Fi networks 10 (specifically, networks 10A-10D) designed for internet connectivity, denoted as Internet 12. These networks adhere to IEEE 802.11 protocols and their variants to provide coverage across different physical locations such as homes, businesses, stores, libraries, schools, parks, etc. The primary difference among these network topologies lies in their coverage extent.

As used herein, the term Wi-Fi network 10 may include physical Wi-Fi networks and/or cloud-based Wi-Fi systems. Similarly, components such as access points 14, mesh nodes 18, repeaters 20, and devices 22 are collectively referred to as nodes, Wi-Fi nodes, or data collection terminals. The primary goal of these components is to facilitate network access to Wi-Fi client devices 16, hereafter mentioned as client devices or Wi-Fi devices, for the purposes of data collection. It's understood by those with relevant expertise that Wi-Fi client devices 16 encompass a wide range of electronics, including mobile devices, tablets, computers, consumer electronics, home entertainment systems, televisions, IoT devices, and/or any device capable of network connectivity.

FIG. 1 shows various non-limiting network architectures used by the system according to some embodiments. For example, network 10A is characterized by a singular access point 14, situated to serve all Wi-Fi client devices 16 within its vicinity. In some embodiments, access point 14 may operate on one or more channels to accommodate bandwidth needs, such as providing specific channels to enable the data collection described herein according to some embodiments. In some embodiments, Network 10B employs a Wi-Fi mesh setup to address some challenges posed by a single access point setup. Network 10B may include multiple mesh nodes 18, creating a highly interconnected network that shares a common channel across all nodes and client devices, thereby facilitating various pathways for data transmission.

In some embodiments, Network 10C includes a topology wirelessly connecting an access point 14 to a Wi-Fi repeater 20, allowing direct communication between them and the Wi-Fi client devices on distinct channels. This configuration addresses the channel-sharing drawback of mesh networks by allowing different communication bands for data hops, enhancing Wi-Fi speed. In some embodiments, one or more repeaters are configured to broadcast distinct SSIDs from the access point 14, making them appear as separate networks to client devices.

System performance issues may occur, especially with real-time media applications which demand high throughput, low latency, and stable connections. Wi-Fi performance is generally hindered by three main factors: interference, congestion, and coverage. Interference becomes a significant issue as the number of Wi-Fi networks increases, with overlapping networks affecting each other's throughput. Congestion within a single network, particularly when handling multiple high-demand applications, can saturate the network's capacity.

In some embodiments, the system is configured to assign one or more access points 14, nodes 18, and/or Wi-Fi repeaters 20 as a data collection terminal. In some embodiments, the system includes one or more data collection terminals outside of a physical structure. However, coverage issues can arise as Wi-Fi signals weaken over distance and when passing through physical barriers, leading to unreliable service in some parts of a home or building. These coverage issues may prevent data from being collected a certain distance outside a physical structure.

To improve Wi-Fi performance, two primary strategies have been explored within networks 10A, 10B, and 10C. The first involves enhancing single access points to strengthen signal coverage and increase data rates. However, this approach faces limitations due to regulatory restrictions on transmission power and the physical laws governing signal propagation. Despite significant efforts, such enhancements may not effectively extend signals through additional barriers.

The second strategy utilizes repeaters or mesh networks to extend Wi-Fi coverage more efficiently. Placing even a single repeater or using a mesh network can significantly reduce signal attenuation caused by physical barriers, offering a more effective solution for expanding coverage. Network 10D exemplifies a tree topology, allowing both wired and wireless interconnectivity among various Wi-Fi devices, differing from the previous configurations by enabling multiple wireless hops and channel use. This setup avoids or minimizes interference and congestion by employing multiple Wi-Fi channels for communication, enhancing network performance. In some embodiments, the system may include any combination of network architectures as the data collection methods described herein can be applied to any device capable of connecting to the internet and/or a cloud server.

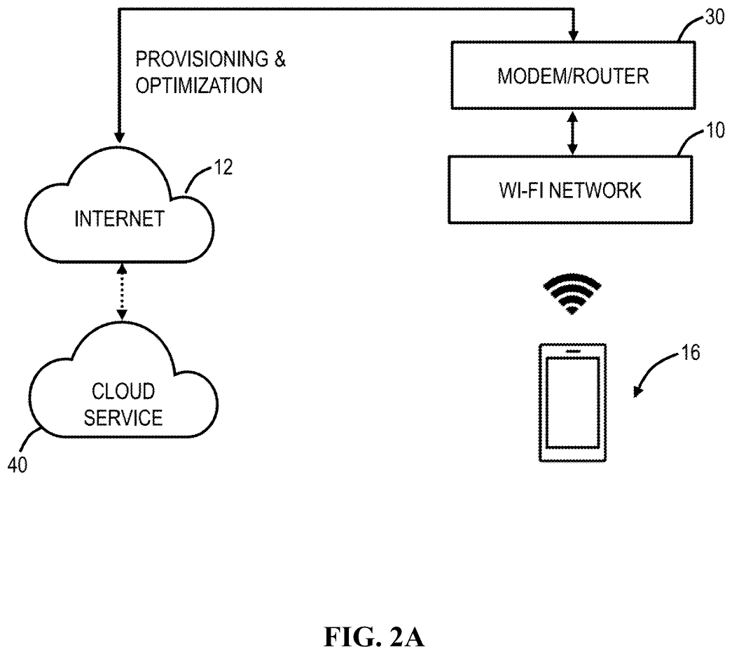

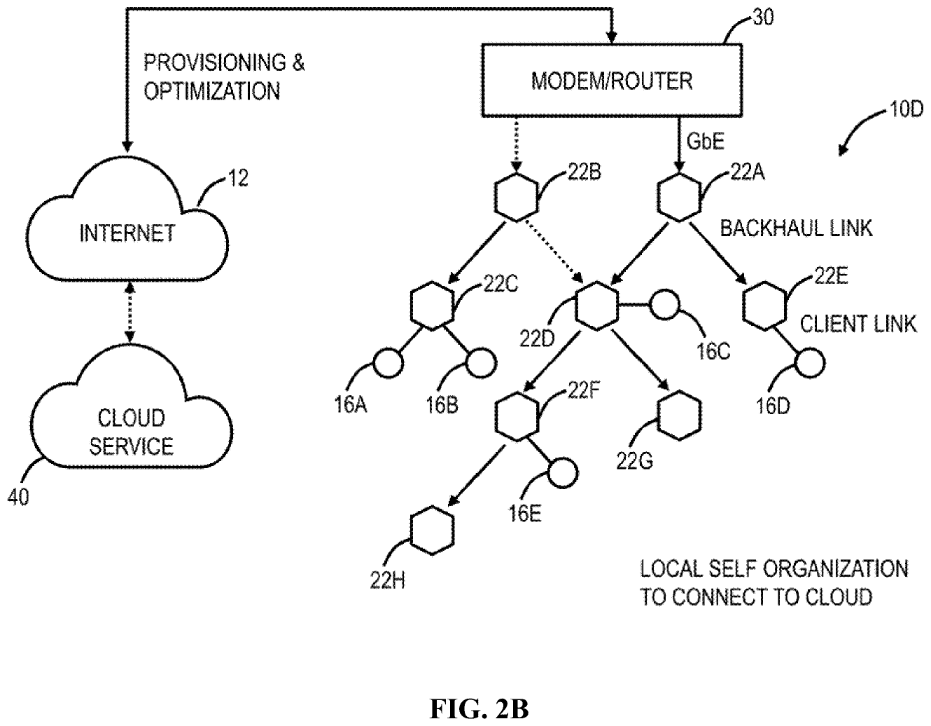

As illustrated in FIG. 2A, in some embodiments, the Wi-Fi network 10 incorporates cloud-based management, connecting through a gateway device such as access points 14, mesh nodes 18, or Wi-Fi devices 22 to a modem/router 30 linked to the internet. This setup enables centralized control over multiple Wi-Fi networks via a cloud service 40 accessible online, enhancing network management for data collection through data analysis and node configuration based on collected measurements, such as signal strength recorded from various client devices. Unlike traditional local setups, this cloud-based approach standardizes interactions between devices and the cloud by using a cloud-agnostic platform for managing home connectivity service data.

Cloud-based control, compatible with various Wi-Fi network configurations, such as those shown in FIGS. 1-3, leverage cloud computing for efficient resource management, enabling scalable and on-demand network access with minimal manual intervention. This method simplifies data application delivery and maintenance, moving away from traditional client-server models towards a centralized cloud-based system, which streamlines data analysis, sorting, and security access assignment.

FIG. 2B introduces network 10D as a distributed system in a tree topology, optimizing for efficiency in environments unsuitable for single access points, repeaters, or mesh networks. By deploying multiple access points throughout a location, this network ensures strong signal coverage and high-quality connectivity for all client devices, minimizing the distance and physical barriers each signal must overcome for data transmission. However, coordinating a large number of access points requires centralized management, which may use cloud-based solutions, to ensure optimal network performance and accessibility.

In optimizing coverage, the distributed Wi-Fi network faces challenges in ensuring all access points work harmoniously. Cloud-based control offers a solution by allowing remote configuration and management, facilitating efficient communication and coordination among access points and client devices. This approach contrasts with traditional methods, emphasizing the importance of cloud integration for advanced network management.

In some embodiments, the access points within the distributed network are capable of both wired and wireless connections, supporting a variety of connectivity options to enhance network flexibility and reliability for data collection. This infrastructure enables efficient data transmission paths and supports a diverse range of client devices, highlighting the advantages of a distributed Wi-Fi network over conventional mesh or repeater-based systems.

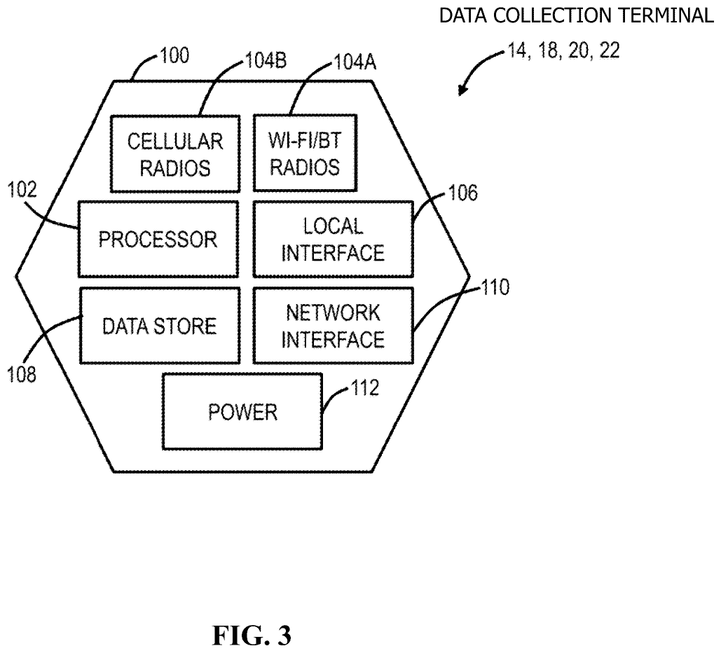

The diagram in FIG. 3 outlines the basic components found in a data broadcast network which includes one or more access points 14, mesh nodes 18, repeaters 20, etc., collectively referred to as a “node,” or “data collection terminal” within one or more Wi-Fi networks 10. In some embodiments, one or more nodes include a compact physical form factor 100 housing one or more of a processor 102, multiple radios 104A, 104B, a local interface 106, a data storage unit 108, a network interface 110, and a power supply 112. FIG. 3 simplifies the actual complexity of such nodes, which in practice might include additional components and sophisticated processing logic to support both the described functionalities and other standard or advanced features not detailed herein.

The form factor 100 is designed for straightforward plug-in installation into an electrical outlet, supporting the widespread deployment of nodes across various premises. The processor 102 serves as the operational brain, executing software instructions for network management, data communication, and general operational control based on the embedded software within the data store 108 or memory. The processor's design allows it to handle both general-purpose tasks and those optimized for mobile or power-efficient applications.

In some embodiments, the dual radios 104A and 104B enable the node to communicate over Wi-Fi and cellular networks, respectively, adhering to standards like IEEE 802.11 for Wi-Fi and various cellular technologies for mobile connectivity. These radios play a role in managing a node's connections across different network types, supporting a wide range of communication requirements. The local interface 106 facilitates initial setup and ongoing communication with the node through a wired or wireless connection, including Bluetooth. This is especially useful during the node's initial integration into the Wi-Fi network, often requiring direct communication with a client device.

In some embodiments, storage 108 serves as the node's memory, storing operational data and software. This component can include one or more volatile and nonvolatile (non-transitory) memory types, such as RAM and hard drives, tailored to the node's needs. The network interface 110 provides the node with a physical connection to the network, which could be essential for nodes that serve as connection points to the modem/router or support wired client devices.

The architecture of these nodes is designed to support not only the data collection functionalities described herein but also future advancements and integrations that may enhance network performance, reliability, and user experience.

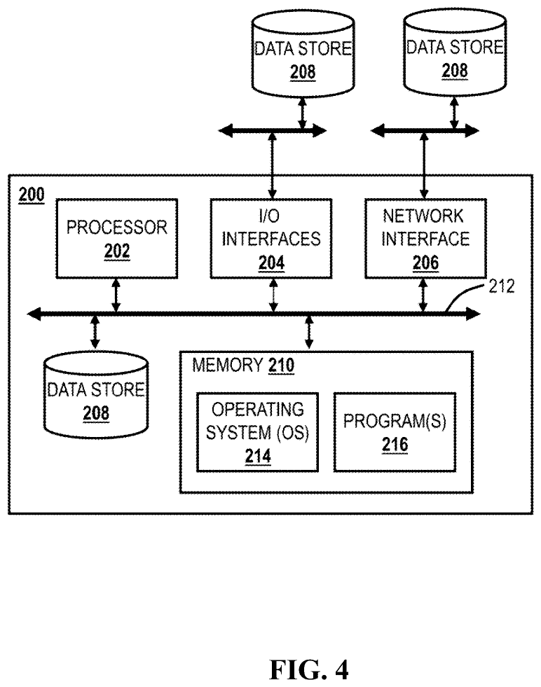

In some embodiments, the system includes one or more computers comprising one or more processors and one or more non-transitory computer readable media. In FIG. 4, the server 200, which may be used in conjunction with a Wi-Fi device and/or a client device, is depicted with its core components, including one or more processors 202, I/O interfaces 204, a network interface 206, data storage 208, and memory 210, interconnected via a local interface 212. This simplified representation underscores the server's capability to support a wide range of functionalities related to cloud-based Wi-Fi network management and optimization, potentially including additional components not specified here.

The server's processor 202 processes instructions stored in memory 210 to manage data flow, network operations, and communication with other network components. I/O interfaces 204 facilitate interaction with external devices and users, while the network interface 206 enables the server to connect to and communicate over the internet or other networks, crucial for cloud-based services.

In some embodiments, data storage 208 offers a repository for operational data, software, and other information, supporting both volatile and nonvolatile memory to ensure data integrity and quick access when needed. Memory 210, comprising a range of storage media, allows the server to execute software and store operational data, supported by a distributed architecture that enhances system performance and reliability.

The system's use of multiple network configurations emphasizes flexibility, scalability, and efficient data management, aligning with the demands of modern cloud-based Wi-Fi networks and supporting a broad spectrum of services and applications to enhance user connectivity and network management during data collection.

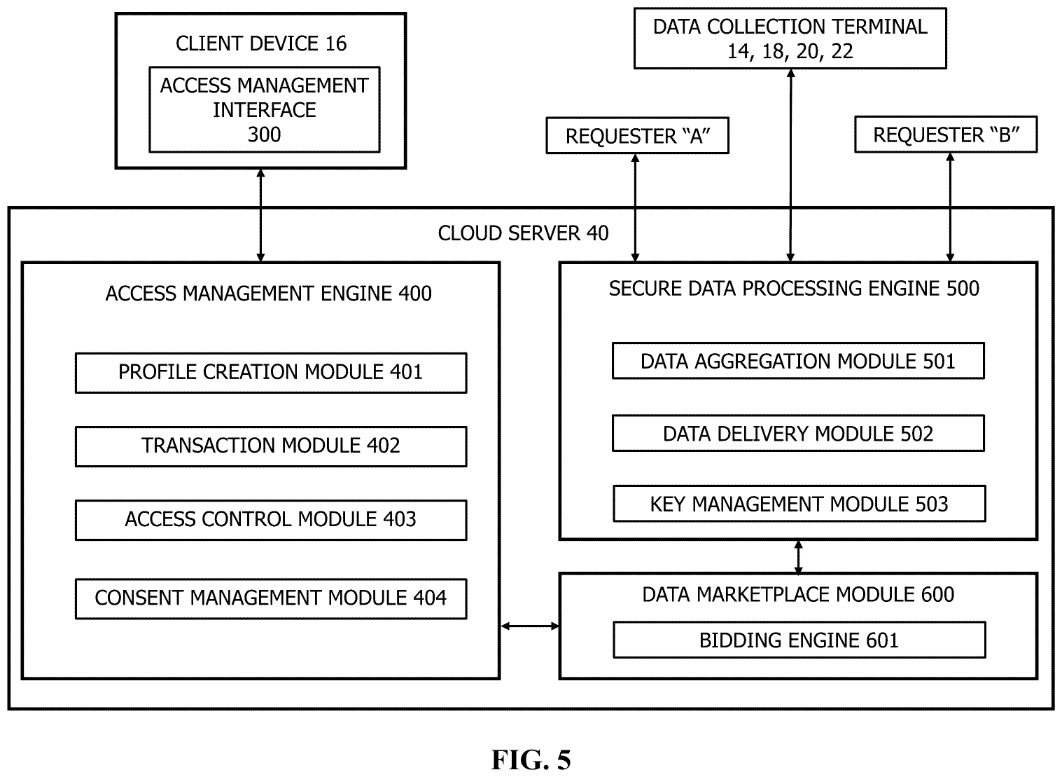

In some embodiments, users interact with the system via a smartphone application, which serves as the data access management interface 300 shown in FIG. 5. HomePass® by Plume Design Inc. serves as a suitable application to host the data access assignments described herein. In some embodiments, the smartphone's Wi-Fi connectivity is used to establish a connection to the cloud network 40, upon user consent, enabling the data collection and/or access to encrypted data. In some embodiments, the App is configured to communicate with cloud service 40 to record a user's data history and/or interaction with one or more smart devices (e.g., 16) and/or data collection terminals 14, 18, 20, and 22.

In some embodiments, the disclosed system operates within a cloud-based environment, where one or more servers are provisioned with modules executing algorithmic steps that enable the functionality described herein. The server may be a singular entity or part of a distributed network of servers interconnected via a network, such as the internet. In some embodiments, the server hosts an access management engine 400 (e.g., application, as discussed herein), which, together with the secure data processing engine 500, enables the secure collection, encryption, and storage of user data, as well as the management of secure access to user data.

Some embodiments described herein include an application (App) configured to display the access management interface 300 on a computing device. In some embodiments, the access management interface 300 is configured to enable system administrators to configure and manage the access of user data, stored on a device or in the cloud, by third parties, also referred to herein as companies or requesters. Through this access management interface 300, administrators can update the system's data security and access management protocols, reflecting changes in user access rights and/or encryption key distribution.

The cloud-based server 40 is communicatively coupled to the internet, enabling secure interactions between the system and authorized data requesters. Various interface devices, such as workstations, laptops, personal digital assistants (PDAs), and cellular phones, can be utilized by authorized requesters to access the system's data store. In some embodiments, secure access to user data is managed through a combination of authentication protocols and encryption key distribution, ensuring that only entities with the requisite authorization can retrieve or manipulate the data.

In some embodiments, the cloud-based server is configured to communicate with a data collection terminal 14, 18, 20, 22, such as a home smart device or Wi-Fi node, through a secure data processing engine 500. In some embodiments, the secure data processing engine 500 is configured for the real-time encryption and transmission of user data from a data collection terminal to the cloud service 40. The secure data processing engine 500 is configured to encrypt data at the point of collection, thereby maintaining data confidentiality from the outset.

In some embodiments, the secure data processing engine 500 is configured to aggregate user data from multiple collection points, which could include various locations or data collection terminals. The aggregation process includes security and encryption of the data, preventing unauthorized access during transmission to the server.

In some embodiments, the system is configured to collect data from a variety of smart appliances within a home setting through one or more data collection terminals. For example, the system may interface with smart refrigerators, which can provide data on usage patterns, inventory levels, and energy consumption. The system may also collect data from smart thermostats, offering insights into household temperature preferences, occupancy patterns, and heating and cooling efficiency. In some embodiments, the system is further configured to collect data from smart entertainment systems, such as smart televisions and speakers. This data can include information on viewing habits, streaming service usage, and audio preferences. Additionally, the system may interface with smart lighting solutions to gather data on lighting usage, ambient light settings, and energy savings.

In some embodiments, the system may also collect data from smart security devices, including smart locks, cameras, and alarm systems. This data can provide information on security events, access logs, and patterns of occupancy. Furthermore, the system may interface with smart home assistants and IoT devices to collect data on voice command usage, automation routines, and device interoperability. All examples presented here are non-limiting as the data collection terminals can receive and process any type of data.

In some embodiments, the secure data processing engine 500 includes a data aggregation module 501 that is configured to aggregate the collected data from these various smart appliances. The data aggregation module 501 processes and anonymizes the data, preparing it for sale on the data marketplace module 600. The aggregated data can provide valuable insights into consumer behavior, energy usage, and home automation trends, which can be of interest to businesses, researchers, and other entities participating in the bidding process enabled by the data marketplace module 600 as further described herein.

In some embodiments, the cloud-based server, equipped with the secure data processing engine 500, receives and stores the encrypted user data, maintaining a secure repository for later access. In some embodiments, user data access permissions, which may be established through the access management interface 300, are processed in accordance with predefined security protocols and access rights associated with each requester's profile.

In some embodiments, the server includes a user profile creation module 401, which allows for the creation and management of profiles for authorized data requesters. Each profile includes specific access rights and parameters, which are used to control the requester's access to the stored user data. The profile creation module 401 ensures that each requester is granted access only to the data they are authorized to view and/or manipulate.

In some embodiments, the secure data processing engine further includes a data delivery module 502. The data delivery module 502 is configured to prepare the encrypted user data for secure transmission to the authorized requester, such as requester A and/or B. In some embodiments, the data delivery module 502 executes a packaging process which includes the application of additional layers of encryption to the data, ensuring its security during transmission. The data delivery module 502 then manages the secure transmission of the packaged data to the requester, if authorized by the user, maintaining the integrity and confidentiality of the data throughout the process.

In some embodiments, the access management engine 400 includes a transaction module 402 configured to maintain a record of each data access transaction, providing an audit trail for security and compensation purposes. This transaction record includes details such as the identity of the requester, the time and date of the request, the specific data accessed, and/or any changes made to the data. This audit trail allows for the tracking and verification of all data access activities, enhancing the overall security of the system.

In some embodiments, the secure data processing engine 500 includes a key management module 503, which is responsible for the generation, distribution, and revocation of encryption keys. In some embodiments, the key management module 503 ensures that each authorized requester is provided with the necessary keys to decrypt the user data they are authorized to access. The key management module 503 also maintains the security of the keys, preventing unauthorized access or duplication.

In some embodiments, the key management module 503 further includes a key revocation mechanism, which allows for the revocation of encryption keys in the event of a security breach or when a requester's access rights are terminated. The revocation process ensures that the compromised or obsolete keys can no longer be used to decrypt the user data, thereby maintaining the security of the data.

In some embodiments, the cloud-based server 40 includes an access control module 403, which manages the access rights and permissions associated with each requester's profile. The access control module 403 ensures that each requester can only access the user data they are authorized to view or manipulate, based on the parameters defined in their profile. The access control module 403 also manages the enforcement of access control policies, preventing unauthorized access to the user data according to some embodiments.

In some embodiments, the system further includes a consent management module 404. The consent management module 404 allows users to grant or revoke consent for the use of their data, and/or ensures user compliance with local privacy regulation. In some embodiments, the consent management module 404 is configured to automatically deny data requests from one or more categories of requesters, ensuring that user data is only used for the purposes that the user has explicitly consented to. For example, if a user would like to exclude a particular company, or category of company, from accessing their data, the user can block the company or companies in the consent management module 404 using the accessing management interface 300.

In some embodiments, the consent management module 404 is configured to enable users to view and manage their consent settings at any time. In some embodiments, the consent management module 404 is configured to display a consent list of entities that have access to their data, the purposes for which their data is being used, and the ability to revoke consent for any or all uses of their data, via access management interface 300. In some embodiments, the consent management module 404 is configured to display one or more consent settings on the access management interface.

In some embodiments, the system further comprises a data marketplace module 600 configured to enable a secure online platform that facilitates the control, auction, and/or sale of anonymized and aggregated user data directly to businesses, researchers, and other entities interested in consumer behavior insights. In some embodiments, the access management interface 300 includes a marketplace interface that enables individual users to offer specific portions or the entirety of their data for public bidding and/or sale.

In some embodiments, the data marketplace module 600 is configured to provide options for anonymity. In some embodiments, via the access management interface 300, a degree of anonymization can be dynamically and/or user-selected for user data by the secure data processing engine 500, ranging from partial to full anonymization, depending on their privacy preferences. In some embodiments, the data marketplace module 600 enables the sale of data while respecting the user's choice for privacy.

In some embodiments, data anonymization, as discussed herein, is a process used to protect the privacy of individuals by removing or altering personally identifiable information from datasets. This is typically achieved through various techniques such as masking, generalization, and/or randomization. Masking involves replacing sensitive data with similar but less revealing values, like replacing names with unique identifiers. Generalization involves aggregating data into broader categories, such as grouping ages into ranges. Randomization involves adding noise or perturbing data points to make it more difficult to identify individuals. By anonymizing data, organizations can still derive valuable insights while minimizing the risk of exposing individuals' identities and sensitive information.

Accordingly, as discussed herein, a technical benefit, among others, in data anonymization is the development of differential privacy techniques. Differential privacy offers a rigorous mathematical framework for quantifying the privacy guarantees of data release mechanisms. It ensures that the presence or absence of any single individual's data makes a negligible difference in the outcome of an analysis, thus protecting individual privacy while still allowing for meaningful data analysis. This approach, as discussed herein, involves adding carefully calibrated noise to query responses or data releases to achieve privacy guarantees.

In some embodiments, the data marketplace module 600 includes a bidding engine 601 that enables the transfer of user data once a precondition is met, such as a winning bid. The bidding engine 601 allows companies, organizations, and other interested parties to participate in the bidding for user data. In some embodiments, the data marketplace module 600 manages the bids in accordance with predefined rules, preconditions, and/or user consent, which may be configured through access management interface 300.

In some embodiments, the data marketplace module 600 is configured to allow users to automatically accept or reject bids based on their personal beliefs and preferences, such as opting not to sell data to entities they consider “bad” companies, regardless of the bid amount. In some embodiments, the data marketplace module 600 is configured to interface with the consent management module 404 to ensure that all data transactions comply with the user's consent settings and privacy preferences.

In some embodiments, the data marketplace module 600 is configured to enable users to structure the sale of their data based on time segments, such as selling data generated during specific hours of the day (e.g., 1 PM-2 PM), or based on data volume (e.g., 1 GB chunks), or a combination of both time and volume. In some embodiments, the data marketplace module 600 is configured to enable a user to sell data from specific applications (Apps) on a user device, while excluding other Apps from the marketplace. In some embodiments, a user can designate one or more smart appliances, devices, or specific sensors as available for sale and/or bidding. This structured sale feature provides users with granular control over the data they choose to sell and enables them to tailor the data packages to the market demand.

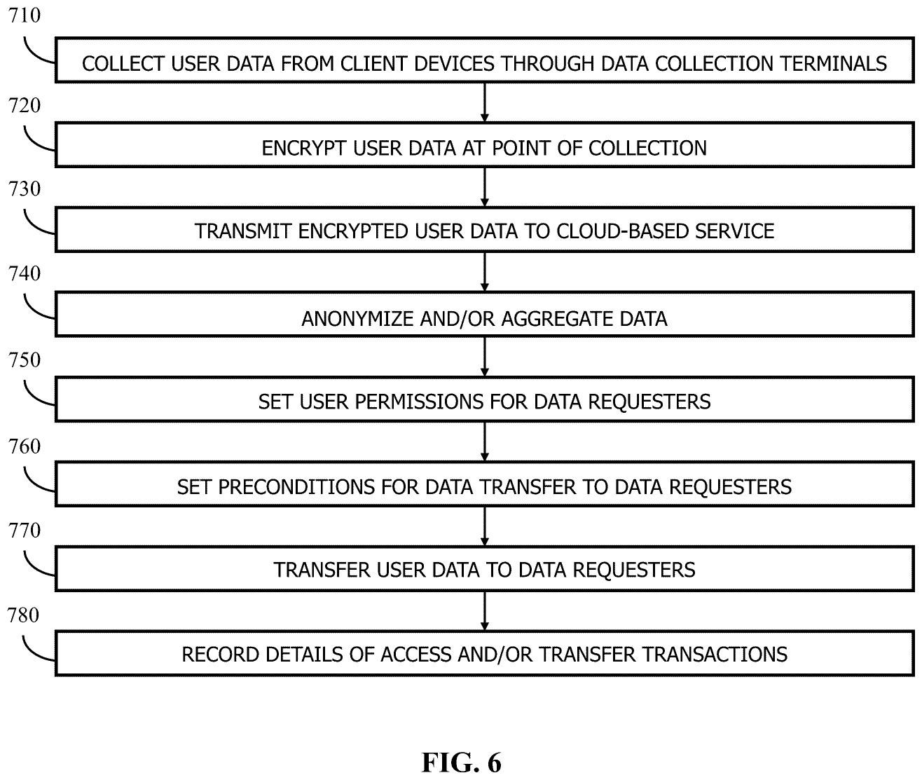

FIG. 6 shows a non-limiting example of algorithmic steps executed by the system for data collection and redistribution according to some embodiments. At Step 710, the system collects data from client devices such as smartphones, tablets, and IoT devices, as they connect and interact with data collection terminals such as Wi-Fi access points, mesh nodes, or repeaters within the network. For example, a user's smartphone may automatically connect to their home Wi-Fi network when in range. While connected, the system collects data regarding the user's browsing habits, app usage, and device information. Upon collection, the secure data processing engine executes real-time encryption of the user data at Step 720, ensuring confidentiality and security. At Step 730, the encrypted data is then securely transmitted to a cloud-based server, where it is stored and managed.

In some embodiments, prior to any potential transfer, at Step 740, the system may anonymize and/or aggregate the data to further protect user privacy and to prepare the data for analysis or marketplace offerings (e.g., modify the data, which in some embodiments, as discussed below, can be based on execution of trained AI/ML models, for example). For example, the system could strip away personal identifiers from the user's data and/or aggregate data from a plurality of smart home devices to generate an anonymized home data profile.

According to some embodiments, for example, a method of anonymizing data can be through hashing. Hashing involves converting sensitive information, like names or identifiers, into a fixed-length string of characters using a cryptographic hash function. This process generates a unique “hash” for each piece of data, making it computationally infeasible to reverse-engineer the original information from the hash.

Another technique that can be implemented is tokenization, where sensitive data is replaced with randomly generated tokens. These tokens have no intrinsic meaning and cannot be used to reconstruct the original data without access to a secure tokenization key. Tokenization preserves the format and length of the original data, making it suitable for applications where data structure is important, such as databases.

In some embodiments, for aggregation, a method that can be used is k-anonymity. K-anonymity ensures that each record in a dataset is indistinguishable from at least k-l other records with respect to certain attributes. This is achieved by grouping records together based on shared attributes and generalizing or suppressing sensitive values within each group. For example, if a dataset contains age information, records with similar ages might be grouped together, and the specific ages might be replaced with age ranges to ensure anonymity.

Similarly, l-diversity extends k-anonymity by ensuring that each group of records not only has k indistinguishable members but also ensures that the sensitive attribute has at least 1 well-represented values within the group. This prevents attacks where adversaries could use background knowledge to infer sensitive information about individuals within a group.

Accordingly, in some embodiments, for both anonymization and aggregation, the goal is to preserve data utility for analysis while protecting individual privacy. These techniques, as implemented herein, offer various levels of privacy guarantees and trade-offs between privacy and utility, depending on the specific requirements of the application and the sensitivity of the data involved.

At Step 750, users grant or revoke consent for data usage and set permissions for which data requesters can access their data. In some embodiments, users or system administrators can define preconditions that must be met before data is transferred to requesters at Step 760, such as the fulfillment of a data purchase agreement or obtaining a winning bid in a data marketplace. Upon meeting the preconditions, at Step 770 the system executes the secure transfer of user data to authorized data requesters. At Step 780, the system records each data access and/or transfer transaction, including the identity of the requester, the time and date of the request, and the specific data accessed or transferred.

In some embodiments, the operations performed in Steps 750 and/or 760 can be performed based on a computational analysis of the anonymized and/or aggregated data (and/or user profile data). That is, the disclosed system can operate, for example to enter the anonymized and/or aggregated data (from Step 740) into an artificial intelligence/machine learning (AI/ML) model, and output determinations of the permissions (Step 750) and conditions (760). This can provide an improvement in the manner the determinations are made as to the accuracy and efficiency, as well as context of such permissions/conditions, which can ensure advanced security measures for user data.

In some embodiments, such analysis and determinations can involve implementation of any type of known or to be known computational analysis technique, algorithm, mechanism or technology to perform the analysis and determination in Steps 750 and 760 (as well, in some embodiments, Step 740, where the anonymization and/or aggregation can be subject to such computerized analysis via the AI/ML discussed herein).

In some embodiments, this may include a specific trained AI/ML models, a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, the system may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like. By way of a non-limiting example, engine 200 can implement an XGBoost algorithm for regression and/or classification to analyze the sensor data, as discussed herein.

According to some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly-received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

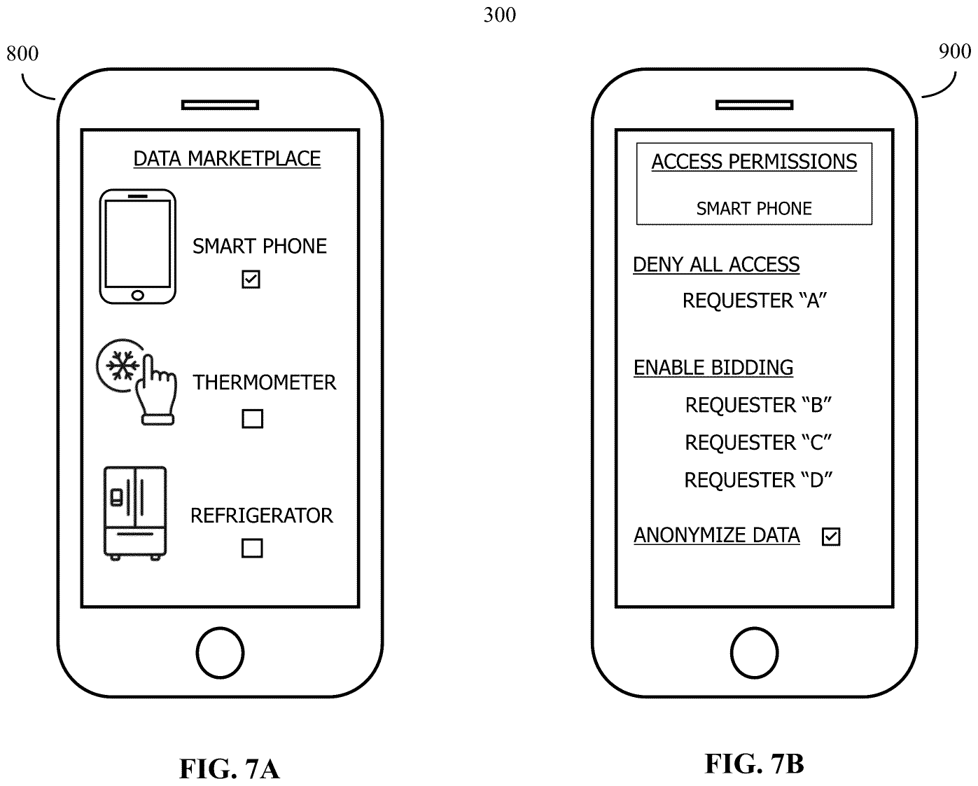

FIG. 7A illustrates an access management interface 300 for the data marketplace 800 according to some embodiments. In some embodiments, the access management interface 300 is configured to display a list of a variety of smart devices under a user's control, including a smartphone, a thermometer, and a refrigerator, each with a corresponding selection icon in this non-limiting example. These select buttons allow users to opt into the data marketplace for each device individually. By selecting a device, users grant permission for the system to collect, encrypt, and potentially redistribute the data generated by that device upon preconditions being met. This could include data such as smartphone usage patterns, temperature readings, and refrigerator usage statistics.

FIG. 7B shows an access management interface 300 for managing access permissions 900 according to some embodiments. In this non-limiting example, the access management interface 300 is configured to display categories for managing data access. The “Deny All Access” category lists Requestor A, indicating that this requester is not granted any access to the user's data. In some embodiments, users can set preconditions for data transfer, such as the fulfillment of a data purchase agreement or obtaining a winning bid. The “Enable Bidding” category lists Requestors B, C, and D, suggesting that these requesters can bid for access to the user's data in the data marketplace. In some embodiments, the access management interface 300 also includes an “Anonymize Data” selection icon, allowing users to choose whether their data should be anonymized before transfer.

The disclosure describes the specifics of how a machine including one or more computers comprising one or more processors and one or more non-transitory computer readable media implements the system and its improvements over the prior art. The instructions executed by the machine cannot be performed in the human mind or derived by a human using a pen and paper but require the machine to convert process input data to useful output data. Moreover, the claims presented herein do not attempt to tie-up a judicial exception with known conventional steps implemented by a general-purpose computer; nor do they attempt to tie-up a judicial exception by simply linking it to a technological field. Indeed, the systems and methods described herein were unknown and/or not present in the public domain at the time of filing, and they provide technologic improvements and advantages not known in the prior art. Furthermore, the system includes unconventional steps that confine the claim to a useful application.

It is understood that the system is not limited in its application to the details of construction and the arrangement of components set forth in the previous description or illustrated in the drawings. The system and methods disclosed herein fall within the scope of numerous embodiments. The previous discussion is presented to enable a person skilled in the art to make and use embodiments of the system. Any portion of the structures and/or principles included in some embodiments can be applied to any and/or all embodiments: it is understood that features from some embodiments presented herein are combinable with other features according to some other embodiments. Thus, some embodiments of the system are not intended to be limited to what is illustrated but are to be accorded the widest scope consistent with all principles and features disclosed herein.

Some embodiments of the system are presented with specific values and/or setpoints. These values and setpoints are not intended to be limiting and are merely examples of a higher configuration versus a lower configuration and are intended as an aid for those of ordinary skill to make and use the system.

Any text in the drawings are part of the system's disclosure and is understood to be readily incorporable into any description of the metes and bounds of the system. Any functional language in the drawings is a reference to the system being configured to perform the recited function, and structures shown or described in the drawings are to be considered as the system comprising the structures recited therein. Any figure depicting a content for display on a graphical user interface is a disclosure of the system configured to generate the graphical user interface and configured to display the contents of the graphical user interface. It is understood that defining the metes and bounds of the system using a description of images in the drawing does not need a corresponding text description in the written specification to fall within the scope of the disclosure.

Furthermore, acting as Applicant's own lexicographer, Applicant imparts the explicit meaning and/or disavow of claim scope to the following terms:

Applicant defines any use of “and/or” such as, for example, “A and/or B,” or “at least one of A and/or B” to mean element A alone, element B alone, or elements A and B together. In addition, a recitation of “at least one of A, B, and C,” a recitation of “at least one of A, B, or C,” or a recitation of “at least one of A, B, or C or any combination thereof” are each defined to mean element A alone, element B alone, element C alone, or any combination of elements A, B and C, such as AB, AC, BC, or ABC, for example.

“Substantially” and “approximately” when used in conjunction with a value encompass a difference of 5% or less of the same unit and/or scale of that being measured.

“Simultaneously” as used herein includes lag and/or latency times associated with a conventional and/or proprietary computer, such as processors and/or networks described herein attempting to process multiple types of data at the same time. “Simultaneously” also includes the time it takes for digital signals to transfer from one physical location to another, be it over a wireless and/or wired network, and/or within processor circuitry.

As used herein, “can” or “may” or derivations thereof (e.g., the system display can show X) are used for descriptive purposes only and are understood to be synonymous and/or interchangeable with “configured to” (e.g., the computer is configured to execute instructions X) when defining the metes and bounds of the system. The phrase “configured to” also denotes the step of configuring a structure or computer to execute a function according to some embodiments.

The previous detailed description is to be read with reference to the figures, in which like elements in different figures have like reference numerals. The figures, which are not necessarily to scale, depict some embodiments and are not intended to limit the scope of embodiments of the system.

Any of the operations described herein that form part of the system are useful machine operations. The system also relates to a device or an apparatus for performing these operations. All flowcharts presented herein represent computer implemented steps and/or are visual representations of algorithms implemented by the system. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general-purpose computer selectively activated or configured by one or more computer programs stored in the computer memory, cache, or obtained over a network. When data is obtained over a network the data can be processed by other computers on the network, e.g., a cloud of computing resources.

The embodiments of the system can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, some embodiments include methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable, and non-removable storage media implemented in any method or technology for the tangible storage of information such as computer-readable instructions, data structures, program modules or other data.

Although method operations are presented in a specific order according to some embodiments, the execution of those steps do not necessarily occur in the order listed unless explicitly specified. Also, other housekeeping operations can be performed in between operations, operations can be adjusted so that they occur at slightly different times, and/or operations can be distributed in a system which allows the occurrence of the processing operations at various intervals associated with the processing, as long as the processing of the overlay operations are performed in the desired way and result in the desired system output.

It will be appreciated by those skilled in the art that while the system has been described above in connection with particular embodiments and examples, the system is not necessarily so limited, and that numerous other embodiments, examples, uses, modifications, and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the system are set forth in the following claims.

What is claimed:

1. A method comprising:
configuring a plurality of Wi-Fi networks to support data collection and to work in a connected manner;
executing a cloud-based server for centralized control over the plurality of Wi-Fi networks;
executing a secure data processing application to perform modification of user data;
enabling secure storage and management of the modified user data through an access management application; and
configuring the access management application to allow a transfer of the user data to one or more data requesters upon one or more preconditions being met.

2. The method of claim 1, further comprising:
utilizing one or more of access points, mesh nodes, repeaters, and devices within the plurality of Wi-Fi networks as data transmission terminals.

3. The method of claim 1, further comprising:
generating an access management interface on a client device, the access management interface configured to enable a user to set the one or more preconditions for the one or more data requesters.

4. The method of claim 1, further comprising:
implementing a consent management module configured to enable users to manage consent settings for data usage transfer.

5. The method of claim 1, further comprising:
executing a user profile creation module configured to create profiles for data requesters, wherein each profile includes access rights.

6. The method of claim 1, further comprising:
configuring a data delivery module to securely transmit the modified data to authorized data requesters.

7. The method of claim 1, further comprising:
configuring a transaction module to maintain records of data access transactions, including one or more of a data requester identification, a time and/or date of request, and data requested.

8. The method of claim 1, further comprising:
executing a key management module configured to manage encryption keys for data requesters, including their generation, distribution, and revocation.

9. The method of claim 1, further comprising:
enabling, via an access management interface, a user to select one or more requesters to add to a consent list.

10. The method of claim 1, further comprising:
configuring the secure data processing application to enable users to select a degree of anonymization for their data via an access management interface.

11. A system comprising:
one or more computers comprising one or more processors and one or more non-transitory computer readable media, the one or more non-transitory computer readable media including program instructions stored thereon that when executed cause the one or more computers to:
configure a plurality of Wi-Fi networks to support data collection and to work in a connected manner;
configure a cloud-based server for centralized control over the plurality of Wi-Fi networks;
execute a secure data processing application to perform modification of user data; and
execute an access management application enabling secure storage and management of the modified data;
wherein the access management application is configured to allow a transfer of user controlled data to one or more data requesters upon one or more preconditions being met.

12. The system of claim 11, wherein the one or more non-transitory computer readable media include further program instructions stored thereon that when executed cause the one or more computers to:
utilize one or more of access points, mesh nodes, repeaters, and devices within the plurality of Wi-Fi networks as data transmission terminals.

13. The system of claim 11, wherein the one or more non-transitory computer readable media include further program instructions stored thereon that when executed cause the one or more computers to:
generate an access management interface on a client device, the access management interface configured to enable a user to set the one or more preconditions for the one or more data requesters.

14. The system of claim 11, wherein the one or more non-transitory computer readable media include further program instructions stored thereon that when executed cause the one or more computers to:
implement a consent management module configured to enable users to manage consent settings for data usage transfer.

15. The system of claim 11, wherein the one or more non-transitory computer readable media include further program instructions stored thereon that when executed cause the one or more computers to:
execute a user profile creation module configured to create profiles for data requesters, wherein each profile includes access rights.

16. The system of claim 11, wherein the one or more non-transitory computer readable media include further program instructions stored thereon that when executed cause the one or more computers to:
configure a data delivery module to securely transmit modified data to authorized data requesters.

17. The system of claim 11, wherein the one or more non-transitory computer readable media include further program instructions stored thereon that when executed cause the one or more computers to:
configure a transaction module to maintain records of data access transactions, including one or more of a data requester identification, time and/or date of request, and specific data requested.

18. The system of claim 11, wherein the one or more non-transitory computer readable media include further program instructions stored thereon that when executed cause the one or more computers to:
execute a key management module configured to manage modification keys for data requesters, including their generation, distribution, and revocation.

19. The system of claim 11, wherein the one or more non-transitory computer readable media include further program instructions stored thereon that when executed cause the one or more computers to:
enable, via an access management interface, a user to select one or more requesters to add to a consent list.

20. The system of claim 11, wherein the one or more non-transitory computer readable media include further program instructions stored thereon that when executed cause the one or more computers to:
configure the secure data processing application to enable users to select a degree of anonymization for their data via an access management interface.
